(19) United States
(12) Patent Application Publication
(10) Pub. No.: US 2026/0101321 A1
(43) Pub. Date: Apr. 9, 2026

(54) TERMINAL, RADIO COMMUNICATION METHOD, AND BASE STATION

(71) Applicant: NTT DOCOMO, INC., Tokyo (JP)

(72) Inventors: Naoya SHIBAIKE, Tokyo (JP); Yuki MATSUMURA, Tokyo (JP); Satoshi NAGATA, Tokyo (JP); Jing WANG, Beijing (CN)

(73) Assignee: NTT DOCOMO, INC., Tokyo (JP)

(21) Appl. No.: 19/113,928

(22) PCT Filed: Sep. 26, 2022
(86) PCT No.: PCT/JP2022/035730

§ 371 Date: Mar. 21, 2025

(51) Int. Cl. H04W 72/0453; H04L 27/26; H04W 72/232

(52) U.S. Cl. CPC H04W 72/0453; H04L 27/2636; H04W 72/232

(57) ABSTRACT

A terminal according to one aspect of the present disclosure includes a receiving section that receives downlink control information (DCI), and a control section that ignores, when a physical uplink shared channel (PUSCH) waveform can be dynamically switched and a discrete Fourier transform-spread-orthogonal frequency division multiplexing (DFT-s-OFDM) waveform is indicated for the PUSCH, at least one of a demodulation reference signal (DMRS) sequence initialization field and a phase tracking reference signal (PTRS)-DMRS related field of the DCI. According to one aspect of the present disclosure, it is possible to appropriately switch a waveform.

### TECHNICAL FIELD

The present disclosure relates to a terminal, a radio communication method, and a base station in next-generation mobile communication systems.

### BACKGROUND ART

In a Universal Mobile Telecommunications System (UMTS) network, Long Term Evolution (LTE) has been specified for the purpose of further increasing high speed data rates, providing lower latency and so on (Non-Patent Literature 1). In addition, for the purpose of further high capacity, advancement and the like of LTE (Third Generation Partnership Project (3GPP (registered trademark)) Release (Rel.) 8 and Rel. 9), LTE-Advanced (3GPP Rel. 10 to Rel. 14) has been specified.

Successor systems of LTE (for example, also referred to as “5th generation mobile communication system (5G),” “5G+(plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1:3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

It is studied to support a cyclic prefix-orthogonal frequency division multiplexing (CP-OFDM) waveform, which is a multi-carrier waveform, in addition to a discrete Fourier transform-spread-orthogonal frequency division multiplexing (DFT-s-OFDM) waveform, which is a single-carrier waveform, in future radio communication systems.

However, since known waveform configuration is performed by Radio Resource Control (RRC), RRC reconfiguration is needed to switch a waveform. This may increase overhead of signaling and deteriorate communication throughput.

Thus, an object of the present disclosure is to provide a terminal, a radio communication method, and a base station that can perform a waveform switching appropriately.

### Solution to Problem

A terminal according to one aspect of the present disclosure includes a receiving section that receives downlink control information (DCI), and a control section that ignores, when a physical uplink shared channel (PUSCH) waveform can be dynamically switched and a discrete Fourier transform-spread-orthogonal frequency division multiplexing (DFT-s-OFDM) waveform is indicated for the PUSCH, at least one of a demodulation reference signal (DMRS) sequence initialization field and a phase tracking reference signal (PTRS)-DMRS related field of the DCI.

### Advantageous Effects of Invention

According to one aspect of the present disclosure, it is possible to perform a wavefrom switching appropriately.

### BRIEF DESCRIPTION OF DRAWINGS

FIG. 1 is a diagram to show a DCI size of option 1-1.

FIG. 2 is a diagram to show a DCI size of option 1-2.

FIG. 3 is a flowchart to show an example of processing of Embodiment 0.1.

FIG. 4 is a flowchart to show an example of processing of Embodiment 0.2.

FIG. 5 is a diagram to show definition of DCI fields, PTRS-DMRS association and DMRS sequence initialization.

FIG. 6 is a diagram to show an example of configuration patterns of useInterlacePUCCH-PUSCH, resourceAllocation, and RA type.

FIG. 7 is a flowchart to show an example of processing of Embodiment 3.

FIG. 8 is a diagram to show an example of a MAC payload.

FIG. 9 is a diagram to show an example of the number of bits of a RAR grant field.

FIG. 10 is a diagram to show examples of a value of a TPC command.

FIG. 11 is a diagram to show examples of a Backoff Parameter value.

FIG. 12 is a diagram to show an example of a schematic structure of a radio communication system according to one embodiment.

FIG. 13 is a diagram to show an example of a structure of a base station according to one embodiment.

FIG. 14 is a diagram to show an example of a structure of a user terminal according to one embodiment.

FIG. 15 is a diagram to show an example of a hardware structure of the base station and the user terminal according to one embodiment.

FIG. 16 is a diagram to show an example of a vehicle according to one embodiment.

### DESCRIPTION OF EMBODIMENTS

### (CP-OFDM and DFT-s-OFDM)

A discrete Fourier transform-spread-orthogonal frequency division multiplexing (DFT-s-OFDM) waveform, which is a single-carrier waveform, is supported in addition to a cyclic prefix-orthogonal frequency division multiplexing (CP-OFDM) waveform, which is a multi-carrier waveform, in the uplink (UL) of radio communication systems (for example, NR). A “waveform” in the present disclosure indicates at least one of a CP-OFDM waveform (CP-OFDM based waveform) and a DFT-s-OFDM waveform (DFT-s-OFDM based waveform).

CP-OFDM allows frequency resource allocation to be performed more flexibly. For example, both contiguous Physical Resource Block (PRB) allocation and noncontiguous PRB allocation are allowed. In addition, the contiguous PRB allocation is not limited to multiples of 2, 3, and 5. When CP-OFDM is applied, frequency division multiplexing (FDM) may be employed for a DeModulation Reference Signal (DMRS) and a PUSCH.

DFT-s-OFDM has rigid constraints on frequency resource allocation, but has a low peak to average power ratio (PAPR) and is hence suitable for a UE with restricted power.

Note that communication throughput not taking account of a PAPR is higher in CP-OFDM than that in DFT-s-OFDM. Communication throughput not taking account of a PAPR in CP-OFDM takes a higher value than that of DFT-s-OFDM when an SNR (MCS) is high (modulation coding scheme is 16QAM or 64QAM). However, such communication throughput in DFT-s-OFDM is higher than that in CP-OFDM when the SNR (MCS) is low (modulation coding scheme is QPSK). In other words, a preferable waveform differs according to SNR (MCS).

Normally, a network (NW) switches a waveform, based on a Signal to Noise Ratio (SNR). Switching between DFT-s-OFDM and CP-OFDM is performed by a transform precoder “transformPrecoder” in an uplink shared channel (Physical Uplink Shared Channel (PUSCH)) configuration (PUSCH-Config) of Radio Resource Control (RRC) signaling. When the transform precoder is disabled, CP-OFDM is applied, and when the transform precoder is enabled, DFT-s-OFDM is applied. For the waveform switching, RRC reconfiguration is needed. This may increase overhead of signaling and deteriorate communication throughput.

### For More Flexible Throughput Control, it Is Conceivable to dynamically switch between CP-OFDM and DFT-s-OFDM by DCI/MAC CE. However, study about such dynamic switching has not been advanced yet.

For Example, in Existing Specifications (for Example, 3gpp Rel. 16), the sizes of some DCI fields of a DCI format (for example, DCI format 0_0/0_1/0_2) are affected by a waveform switching, as described in (1) to (6) below.
(1) In the “Precoding information and number of layers” field, different tables are used for two waveforms.
(2) In the “Antenna ports” field, different tables are used for two waveforms.
(3) The “DMRS sequence initialization” field is of 0 bit when the transform precoder is enabled while being of 1 bit when the transform precoder is disabled.
(4) In the “PTRS-DMRS association” field, the DCI size is affected by the transform precoder.
(5) In the “Frequency domain resource assignment,” the DCI size differs depending on resource assignment type. In addition, supported resource assignment differs depending on waveform. CP-OFDM supports resource assignment types 0, 1, and 2, while DFT-s-OFDM supports resource assignment type 1 and 2.
(6) In the “Frequency hopping flag” field, the DCI size differs depending on resource assignment type. As described above, supported resource assignment differs depending on waveform.

### (Dynamic Switching Between Disabling and Enabling of Transform Precoder)

A UE may receive a configuration indicating that disabling and enabling of a transform precoder for a PUSCH are dynamically switched by DCI/MAC CE. The UE may then receive an indication of disabling or enabling of the transform precoder for the PUSCH, by DCI/MAC CE. Dynamic switching by DCI/MAC CE will be referred to simply as dynamic switching in some cases below. Note that the UE may be configured with dynamic switching of the waveform/transform precoder (switching being possible) by higher layer signaling or the like in advance. Dynamic switching of a transform precoder by DCI/MAC CE may be possible irrespective of whether the configuration is present or absent.

For example, DCI-signaling-based dynamic waveform switching may be performed implicitly or explicitly. For example, a 1-bit field indicating a CP-OFDM or DFT-s-OFDM waveform to be used for the PUSCH may be included in DCI (explicit signaling). For example, the UE may determine/identify a CP-OFDM or DFT-s-OFDM waveform to be used for the PUSCH, according to a specific condition of scheduling information and the like in the DCI (implicit signaling). In this case, an existing DCI format is not changed.

Alternatively, MAC-CE-signaling-based dynamic UL waveform switching may be performed. For example, a 1-bit field indicating a CP-OFDM or DFT-s-OFDM waveform to be used for the PUSCH may be included in a MAC CE (explicit signaling). Alternatively, the UE may determine/identify a CP-OFDM or DFT-s-OFDM waveform to be used for the PUSCH, based on an existing field of the MAC CE (implicit signaling).

A DCI format in the present disclosure may indicate DCI format 0_0/0_1/0_2 or may be another format (for example, DCI format 0_3 for notification of waveform switching), for example.

As the other format, group common DCI as DCI format 2_x may be used, for example. In this case, a certain time after reception of DCI format 2_x and transmission of ACK, the UE may apply waveform switching.

Switching between disabling and enabling of a transform precoder (switching of a waveform) in the present disclosure may be waveform switching in the same BWP (switching a waveform without switching a BWP). For example, since a different transform precoder can be configured for each BWP, it is conceivable to perform switching of a transform precoder by BWP switching. However, since BWP switching causes delay, the delay can be suppressed by switching disabling and enabling of a transform precoder in the same BWP.

When dynamic switching between disabling and enabling of the transform precoder for the PUSCH by DCI/MAC CE is configured, the UE may receive an indication indicating enabling or disabling of the transform precoder for the PUSCH by DCI/MAC CE, and switch a waveform (CP-OFDM/DFT-s-OFDM) to be used for the PUSCH, based on the indication.

The total DCI size of a DCI format may be uniform irrespective of whether a transform precoder is to be disabled or enabled. The size of DCI format may be configured/determined by higher layer signaling (RRC). In other words, the size of DCI format need not depend on DCI/MAC CE.

However, for some DCI fields, the size of each DCI field may differ according to whether a transform precoder is to be disabled or enabled. Examples of the some DCI fields include “Precoding information and number of layers,” “Antenna ports,” “DMRS sequence initialization,” “PTRS-DMRS association,” “Frequency resource assignment,” and “Frequency hopping flag.” For example, the DCI size may differ as shown in (1) to (6) of the existing specifications described above.

### {Option 1-1}

When dynamic switching of a transform precoder for a PUSCH (switching by DCI/MAC CE) is configured for a PUSCH, the total size of each DCI format may be a larger one of the size of the DCI format when the transform precoder is disabled and the size of the DCI format when the transform precoder is enabled.

When the transform precoder is disabled/enabled by a MAC CE, the UE may read each DCI field from the least significant bit (LSB) according to the size of the DCI field. Alternatively, the UE may read each DCI field from the most significant bit (MSB).

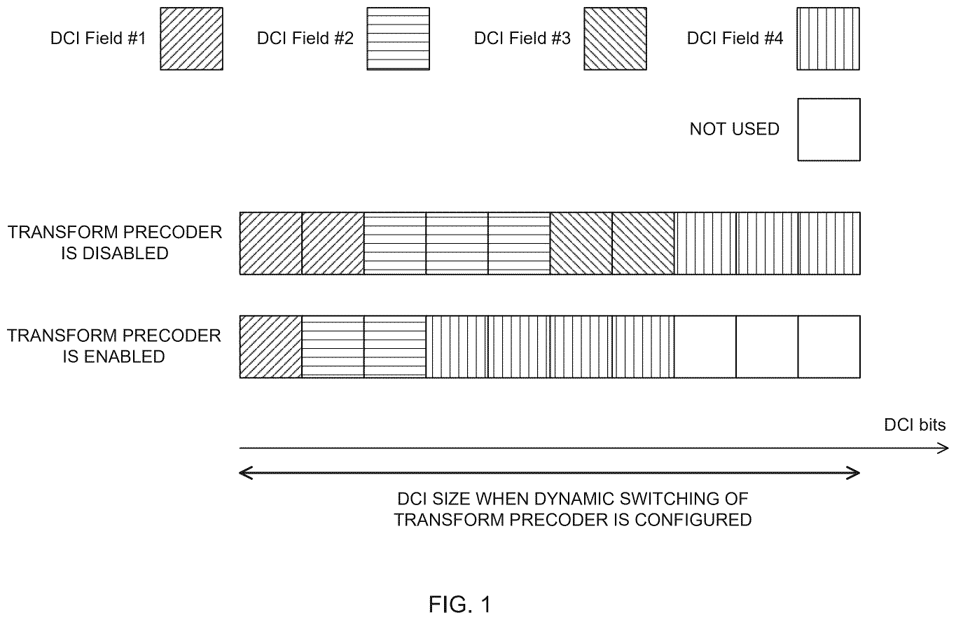

FIG. 1 is a diagram to show a DCI size of option 1-1. According to FIG. 1, the number of DCI bits (total of DCI Fields #1 to #4) when a transform precoder is disabled is 10 bits, and the number of DCI bits when a transform precoder is enabled is 7 bits. In this case, 10 bits, which is the larger DCI size, are used for the total size of DCI when dynamic switching of a transform precoder is configured.

In FIG. 1, the DCI bits corresponding to the smaller DCI size (DCI bits when a transform precoder is enabled) are mapped consecutively from the left (least significant bit) but may be mapped consecutively from the right (most significant bit). In other words, the UE may read each DCI field from the least significant bit or may read each DCI field from the most significant bit.

In option 1-1, the total size of DCI can be smaller than that in option 1-2 to be described below.

### {Option 1-2}

When dynamic switching of a transform precoder for a PUSCH is configured for a PUSCH, a larger one of the size of the DCI format when the transform precoder is disabled and the size of the DCI format when the transform precoder is enabled may be determined for each field for each DCI format, and the total size of the DCI format may be the total value of the larger sizes of all the DCI fields.

Specifically, if the number of fields of a certain DCI format is N, the total size of the DCI format is calculated as follows. The total size of the DCI format=Σ(MAX (the size of DCI field i when a transform precoder is disabled, the size of DCI field i when a transform precoder is enabled)) (i=1 to N)

When the transform precoder is disabled/enabled by a MAC CE, the UE may read each DCI field from the least significant bit (LSB) according to the size of the DCI field. Alternatively, the UE may read each DCI field from the most significant bit (MSB).

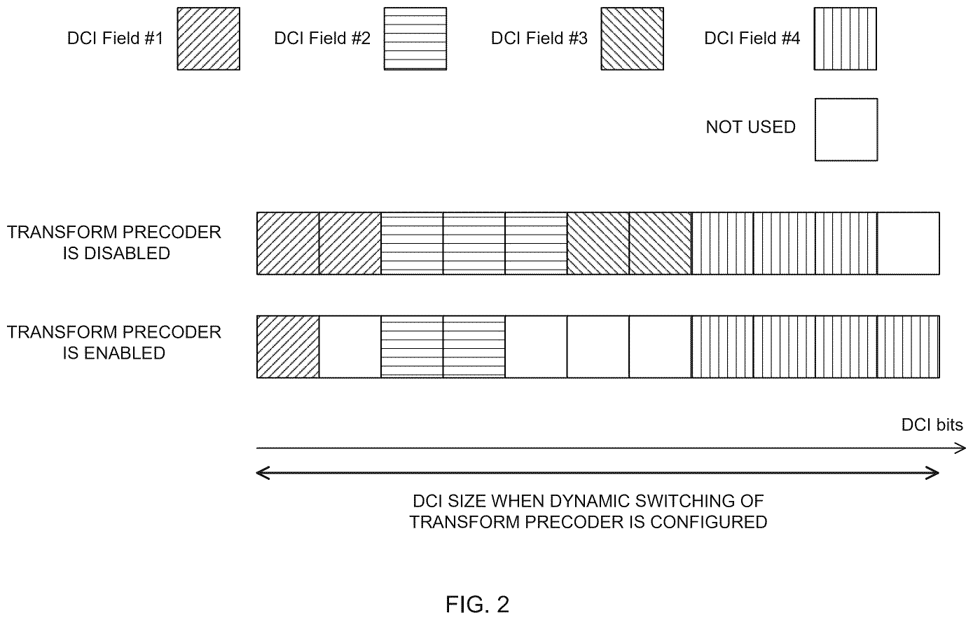

FIG. 2 is a diagram to show a DCI size of option 1-2. According to FIG. 2, in DCI Field #1, the larger one of the size of the DCI field when a transform precoder is disabled (2 bits) and the size of the DCI field when the transform precoder is enabled (1 bit) is 2 bits. Similarly, the larger size is 3 bits for DCI Field #2, 2 bits for DCI Field #3, and 4 bits for DCI field #4. By adding these sizes (2+3+2+4=11), 11 bits are used for the total size of DCI when dynamic switching of a transform precoder is configured.

In FIG. 2, the DCI bits in the fields corresponding to the smaller DCI size are mapped consecutively from the left (least significant bit) but may be mapped consecutively from the right (most significant bit). In other words, the UE may read each DCI field from the least significant bit or may read each DCI field from the most significant bit.

In the example in FIG. 2, the bit at the start position of each field (bit range used for each field) is the same for a case where the transform precoder is disabled and a case where the transform precoder is enabled. For example, the start position of DCI Field #1 is the first bit, the start position of DCI Field #2 is the third bit, the start position of DCI Field #3 is the sixth bit, and the start position of DCI Field #4 is the eighth bit. This facilitates processing of detecting each field by the UE.

In option 1-2, since a DCI size to be detected is the same even when enabling/disabling of a transform precoder is switched, increase in processing load for the UE can be suppressed.

### (FDRA Types)

In NR, three types including Type 0, Type 1, Type 2 below are supported as types of frequency domain resource allocation (FDRA) types.
Type 0: allocation based on a bitmap (in other words, allocation may be non-contiguous)
Type 1: contiguous allocation based on a resource indication value (RIV)
Type 2: interlace arrangement (for NR)

Applicability depending on a PUSCH waveform of each type may be supported as follows.
Type 0: Applicable only to CP-OFDM
Type 1: Applicable to both CP-OFDM and DFTS-OFDM
Type 2: Applicable to both CP-OFDM and DFTS-OFDM

When an RRC parameter useInterlacePUCCH-PUSCH is not configured, Type 0 or Type 1 is used according to an RRC parameter resourceAllocation. When UL data of Type 1 is transmitted without grant, resourceAllocationType0 or resourceAllocationType1 is configured as resourceAllocation. When resourceAllocationType0 is configured, Type 0 is used, and when resourceAllocationType1 is configured, Type 1 is used. When dynamicSwitch is configured, Type 0 or Type 1 is indicated by scheduling DCI (MSB of FDRA).

When useInterlacePUCCH-PUSCH is configured, Type 2 is used.

### (Analysis)

Since known waveform configuration is performed by Radio Resource Control (RRC), RRC reconfiguration is needed to switch a waveform. This may increase overhead of signaling and deteriorate communication throughput. By performing dynamic switching of a transform precoder for a PUSCH (switching by DCI/MAC CE) as described above, this allows a waveform switching to be performed easily (at a higher speed). However, in this case, there are some unclear respects about various kinds of configuration/control as described in problems 0 to 3 below.

Thus, the inventors of the present invention came up with the idea of a terminal that appropriately performs dynamic switching between disabling and enabling of a transform precoder (switching of a waveform) for a PUSCH.

Embodiments according to the present disclosure will be described in detail with reference to the drawings as follows. The radio communication methods according to respective embodiments may each be employed individually, or may be employed in combination.

In the present disclosure, “A/B” and “at least one of A and B” may be used interchangeably. In the present disclosure, “A/B/C” may mean “at least one of A, B, and C.”

In the present disclosure, “notify,” “activate,” “deactivate,” “indicate,” “select,” “configure,” “update,” “determine,” and the like may be used interchangeably. In the present disclosure, “support,” “control,” “can control,” “operate,” “can operate,” and the like may be used interchangeably.

In the present disclosure, radio resource control (RRC), an RRC parameter, an RRC message, a higher layer parameter, a field, an information element (IE), a configuration, and the like may be used interchangeably. In the present disclosure, a Medium Access Control control element (MAC Control Element (CE)), an update command, an activation/deactivation command, and the like may be used interchangeably.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or O the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be used interchangeably. In the present disclosure, a sequence, a list, a set, a group, a cluster, a subset, and the like may be used interchangeably.

In the present disclosure, CP-OFDM being applied/used and a transform precoder (transformPrecoder) being disabled may be used interchangeably. DFT-s-OFDM being applied/used and a transform precoder being enabled may be used interchangeably. A transform precoder being disabled/enabled, a transform precoder being switched, and a waveform (CP-OFDM/DFT-s-OFDM) being switched may be used interchangeably. A PUSCH waveform, a waveform, and a transform precoder may be used interchangeably. CP-OFDM and a CP-OFDM waveform may be used interchangeably. DFT-s-OFDM and a DFT-s-OFDM waveform may be used interchangeably. Enabled and on may be used interchangeably. Disabled and off may be used interchangeably. A “case where a PUSCH waveform can be dynamically switched” and a “case where dynamic switching of a PUSCH waveform is configured” may be used interchangeably.

### (Radio Communication Method)

As described above, a UE may receive a configuration indicating that disabling and enabling of a transform precoder for a PUSCH are dynamically switched by DCI/MAC CE. The UE may then receive an indication of disabling or enabling of the transform precoder for the PUSCH, by DCI/MAC CE. In other words, the UE may be able to dynamically switch a PUSCH waveform. In this case, at least one of processes of some embodiments below may be employed.

In the present disclosure, when a PUSCH waveform can be dynamically switched, at least one of the methods (in dynamic switching between disabling and enabling of a transform precoder) described above may be employed.

### <Problem 0>

When the PUSCH waveform can be dynamically switched, it is not clear what values should be configured for RRC parameters transformPrecoder and maxRank. For example, for transformPrecoder, a value corresponding to any of enabled (i.e., DFT-s-OFDM), disabled (i.e., CP-OFDM), and no restriction is expected. For example, the configuration of the RRC parameter transformPrecoder affects a DCI size, which affects processing load of a UE and communication overhead, and hence it is preferable to make the configuration clear.

### EMBODIMENT 0.1

When a PUSCH waveform can be dynamically switched, the UE may apply a configuration of any of the following aspects to the RRC parameter transformPrecoder.

### {Aspect 1}

When a PUSCH waveform can be dynamically switched, the RRC parameter transformPrecoder may be configured to enabled. This can reduce the DCI size assumed by the UE. In other words, an NW (base station, gNB) can configure a small DCI size, which can suppress communication overhead.

### {Aspect 2}

When a PUSCH waveform can be dynamically switched, the RRC parameter transformPrecoder may be configured to disabled. With this, even when the PUSCH waveform is switched to DFT-s-OFDM, the UE assumes the same DCI size as that for CP-OFDM, which can hence reduce the processing load of the UE.

### {Aspect 3}

When a PUSCH waveform can be dynamically switched, the RRC parameter transformPrecoder may be ignored. In other words, there may be no restriction on transformPrecoder.

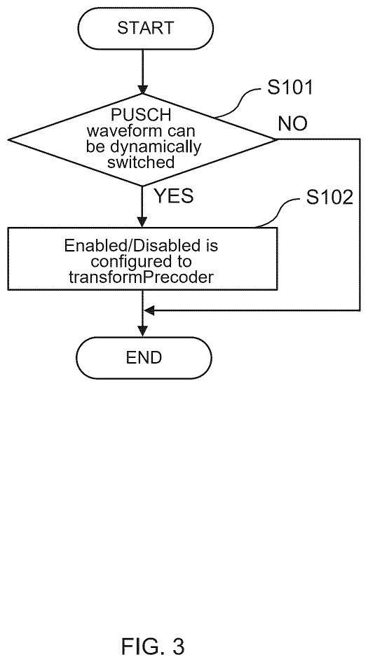

FIG. 3 is a flowchart to show an example of processing of Embodiment 0.1. When the UE receives a configuration indicating that a PUSCH waveform can be dynamically switched (step S101), the UE receives an RRC parameter transformPrecoder to which enabled/disabled is configured (step S102).

As an RRC parameter, a plurality of transformPrecoder are present, but transformPrecoder to which the UE refers may be different for each case (each timing). For example, options 1 and 2 below may be employed. When dynamic switching of a PUSCH waveform is configured, the processes in options 1 and 2 below may be applied at timing before indication of the dynamic switching of a PUSCH waveform.

### {Option 1}

The UE may refer to/consider transformPrecoder in an RRC IE (for example, PUSCH-Config or ConfiguredGrantConfig) corresponding to a PUSCH to transmit. This option may be applied to the UE after dedicated (UE-specific) RRC configuration.

### {Option 2}

The UE may refer to/consider transformPrecoder in a specific RRC IE (for example, msg3-transformPrecoder in RACH-ConfigCommon or the like) irrespective of type of a PUSCH. This option may be applied to the UE before dedicated (UE-specific) RRC configuration.

According to this embodiment, when a PUSCH waveform can be dynamically switched, values to be configured and UE operation for the RRC parameter transformPrecoder can be made clear.

### EMBODIMENT 0.2

When a PUSCH waveform can be dynamically switched, the UE may receive a value/configuration based on any of the following aspects/options as an RRC parameter maxRank. In other words, the UE may assume application of any of the following aspects/options for the value/configuration of maxRank. maxRank is a parameter indicating the maximum value of UL (PUSCH) transmission rank (layer). The UE controls transmission of a PUSCH, based on maxRank.

### Aspect 1

There may be no restriction on the configuration of maxRank. In other words, even when dynamic switching of a PUSCH waveform is configured, any value may be configured for maxRank.

### Aspect 2

A specific value or a value smaller than a specific value may be configured for maxRank. The specific value may be determined (fixed) by specifications, for example. The specific value may be configured/indicated by RRC/MAC CE/DCI. For example, when dynamic switching of a PUSCH waveform is configured, maxRank (specific value) may be 1.

When maxRank is restricted, for example only 1 can be configured for maxRank, the bit width of a Transmitted Precoding Matrix Indicator (TPMI) is the same irrespective of PUSCH waveform. In other words, the DCI size is the same, which can reduce the processing load of the UE.

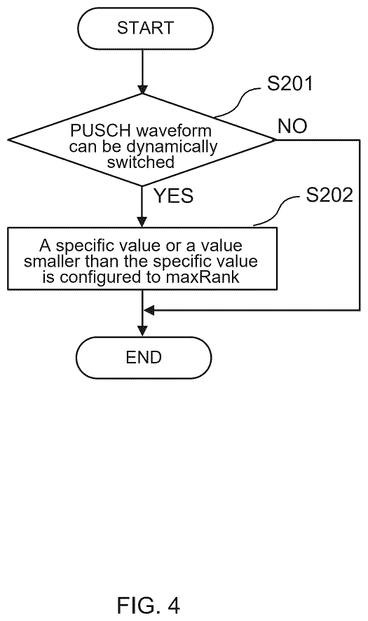

FIG. 4 is a flowchart to show an example of processing of Embodiment 0.2. FIG. 4 shows an example of aspect 2 above. When the UE receives a configuration indicating that a PUSCH waveform can be dynamically switched (step S201), the UE receives a configuration indicating a specific value or a value smaller than the specific value as the value of the RRC parameter maxRank (step S202).

According to this embodiment, when a PUSCH waveform can be dynamically switched, a value to be configured for the RRC parameter maxRank can be made clear.

### Problem 1

When a PUSCH waveform can be dynamically switched, how to treat a DCI field that is present in some cases (1 or more bits) and is not present in other cases (0 bit) depending on PUSCH waveform. Examples of the DCI field include PTRS-DMRS association and DMRS sequence initialization.

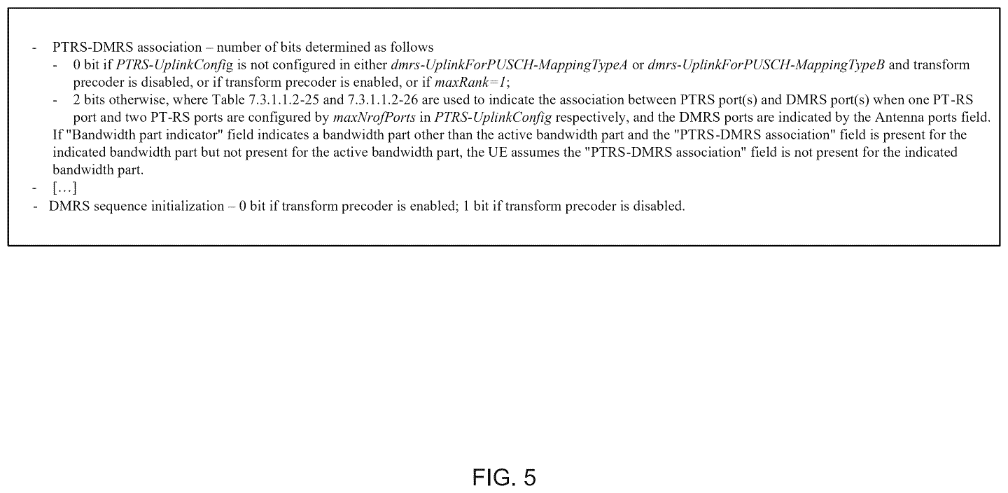

FIG. 5 is a diagram to show definition of DCI fields, PTRS-DMRS association and DMRS sequence initialization. As shown in FIG. 5, DMRS sequence initialization is of 0 bit if PTRS (PTRS-UplinkConfig) is not configured and CP-OFDM is applied (transform precoder is disabled), if DFTS-OFDM is applied (if transform precoder is enabled), or if maxRank=1, and is of 2 bits otherwise. DMRS sequence initialization is of 0 bit if the DFTS-OFDM is applied and is of 1 bit when CP-OFDM is applied.

### FIRST EMBODIMENT

When a PUSCH waveform can be dynamically switched and a specific waveform is indicated for a PUSCH, a UE may process (assume) a specific field of scheduling DCI for a PUSCH, based on a specific rule.

The specific field of DCI may be at least one of a demodulation reference signal (DMRS) sequence initialization field and a phase tracking reference signal (PTRS)-DMRS association (PTRS-DMRS association) field.

The specific rule may be that a UE ignores the specific field of DCI.

The specific waveform may be DFT-s-OFDM or CP-OFDM.

For example, the UE receives DCI, and when a PUSCH waveform can be dynamically switched and DFT-s-OFDM is indicated for a PUSCH, ignores at least one of a DMRS sequence initialization field and a PTRS-DMRS association field of the DCI.

Without the example above being restrictive, when a condition for the DMRS sequence initialization field or the PTRS association field in FIG. 5 being of 0 bit is satisfied, the UE may ignore the field. This can reduce the processing load of the UE.

In the first embodiment, when a PUSCH waveform can be dynamically switched, the number of bits of each DCI field/size of the entire DCI may conform to the rule for a case of CP-OFDM irrespective of an accurate waveform used by the UE. Alternatively, the number of bits of each DCI field/size of the entire DCI need not conform to the rule for a case of CP-OFDM.

### <Problem 2>

As described above (FDRA type), Type 0 RA cannot be used for DFT-s-OFDM, and hence Type 1 or Type 2 need be used when a PUSCH waveform is switched to DFT-s-OFDM. For example, an RRC parameter indicating a PUSCH waveform preferably always corresponds to the configuration/indication of an FDRA type. However, when a PUSCH waveform is dynamically switched, a configuration of FDRA or indication of use of interlace (useInterlacePUCCH-PUSCH) is not clear.

### SECOND EMBODIMENT

When a PUSCH waveform can be dynamically switched and a specific waveform is indicated for a PUSCH, a UE may receive a specific field of DCI and a specific RRC (may assume reception of the specific field of the DCI and the specific RRC parameter) corresponding to scheduling of the PUSCH. The UE may control PUSCH transmission, based on the specific field of the DCI and the specific RRC parameter thus received.

The specific field of the DCI may be FDRA or a frequency hopping flag.

The specific RRC parameter may be resource allocation (resourceAllocation) or use indication of interlace of a PUCCH and a PUSCH (useInterlacePUCCH-PUSCH).

The specific waveform may be DFT-s-OFDM or CP-OFDM.

The specific rule may be that resourceAllocation is either resourceAllocationType1 or dynamicSwitch. When resourceAllocation is dynamicSwitch, the most significant bit (MSB) of FDRA need be “1.” In other words, FDRA Type 1 need be indicated. This specific rule may be applied when useInterlacePUCCH-PUSCH is not configured.

The specific rule may be that resourceAllocation is resourceAllocationType1.

The specific rule may be that the frequency hopping is determined in accordance with at least one of resourceAllocation and FDRA based on the specific rule.

The specific rule may be that useInterlacePUCCH-PUSCH (use of interlace for a PUCCH and a PUSCH) is configured at enabled (or may be use of interlace for a PUCCH and a PUSCH).

### Concrete Examples

For Example, When a Pusch Waveform Can Be Dynamically switched and DFT-s-OFDM is indicated for a PUSCH, a UE may receive configuration information (RRC parameter) indicating dynamicSwitch as resourceAllocation and indication information (DCI) indicating Type 1 as FDRA (may assume the reception). The UE may control PUSCH transmission, based on the configuration information and the indication information.

For example, when a PUSCH waveform can be dynamically switched and DFT-s-OFDM is indicated for a PUSCH, the UE may receive configuration information (RRC parameter) indicating Type 1 as resourceAllocation (resourceAllocationType1) (may assume the reception). The UE may control PUSCH transmission, based on the configuration information.

For example, when a PUSCH waveform can be dynamically switched and DFT-s-OFDM is indicated for a PUSCH, the UE may receive configuration information indicating useInterlacePUCCH-PUSCH (use of interlace for a PUCCH and a PUSCH) is enabled (may assume the reception). The UE may control PUSCH transmission, based on the configuration information.

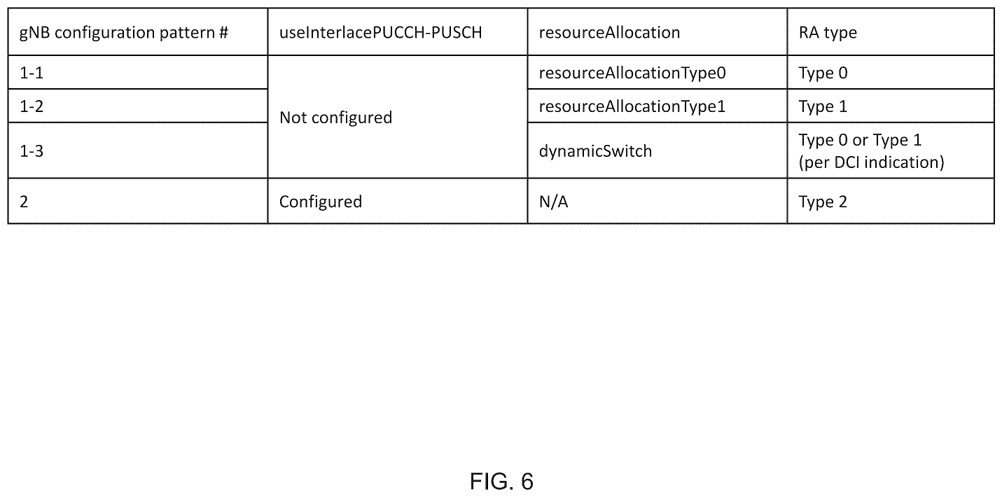

FIG. 6 is a diagram to show an example of configuration patterns of useInterlacePUCCH-PUSCH, resourceAllocation, and RA type. When dynamic waveform switching is possible, (1) and (2) below may be applied to the configuration patterns shown in FIG. 6.
(1) When a default value of transformPrecoder corresponds to disabled (CP-OFDM is indicated/used), the UE can expect any pattern. However, when the default value corresponds to enabled (DFT-s-OFDM is indicated/used), patterns 1-1 and 1-3 need not be applied.
(2) When a default value of transformPrecoder corresponds to enabled, the UE can expect a pattern other than patterns 1-1 and 1-3 in which DCI indicating Type 0 is applied. However, when CP-OFDM is indicated/used, the UE may expect any pattern.

The processing of this embodiment may be employed irrespective of a waveform indicated for a PUSCH. Specifically, when a PUSCH waveform can be dynamically switched, a UE may control the specific field of DCI corresponding to scheduling of a PUSCH and the specific RRC parameter above, based on the specific rule above.

According to this embodiment, even when a PUSCH waveform can be dynamically switched, a case being an error (for example, Type 0 FDRA is configured when DFT-s-OFDM is employed) can be avoided.

### <Problem 3>

When a PUSCH waveform can be dynamically switched, the applicable type(s) of PUSCH is not clear. For example, whether message 3 (Msg3)/message A (msg3-TransformPrecoder/msgA-TransformPrecoder) is applicable as the PUSCH is not clear. In addition, whether CG-PUSCH (transformPrecoder in ConfiguredGrantConfig) is applicable as the PUSCH is not clear. When dynamic switching of a PUSCH waveform is supported for these PUSCHs, which processing is performed is not clear.

### EMBODIMENT 3

A UE may apply dynamic switching of a PUSCH waveform only to a particular type(s) of PUSCH. Specifically, when the UE receives a configuration indicating that a PUSCH waveform is dynamically switched, the UE may control to dynamically switch only the particular type(s) of PUSCH, based on DCI/MAC CE. The particular type(s) of PUSCH may be at least one of (1) to (4) below, for example.
(1) DCI Grant (DG)-PUSCH (PUSCH scheduled by DCI)
(2) Type 1 configured grant (CG)-PUSCH (PUSCH transmission configured by higher layer signaling)
(3) Type 2 CG-PUSCH (PUSCH transmission configured by higher layer signaling and activated/deactivated by DCI)
(4) PUSCH scheduled by a random access response (RAR) (message 3 PUSCH or message A PUSCH). This RAR may be contention based random access (CBRA) RAR or contention-free random access (CFRA) RAR. For example, since a base station (gNB) knows a UE and the channel state of the UE in CFRA, a waveform can be appropriately adjusted.

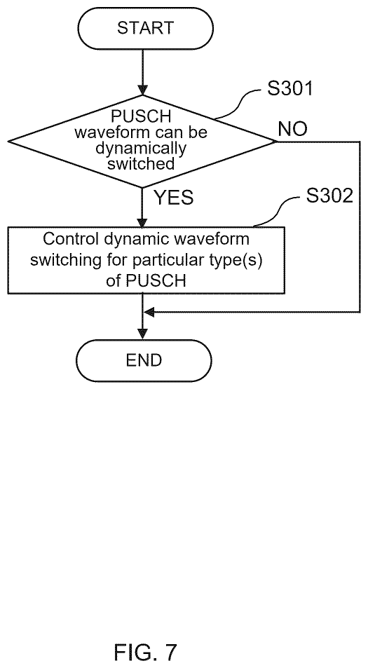

FIG. 7 is a flowchart to show an example of processing of Embodiment 3. When a UE receives a configuration indicating that a PUSCH waveform can be dynamically switched (step S301), the UE controls to dynamically switch only the particular type(s) of PUSCH, based on DCI/MAC CE (step S302).

### EMBODIMENT 4.1

Dynamic switching of a Type 1 CG-PUSCH (PUSCH transmission configured by higher layer signaling) waveform may be performed, and at least one method of (1-1) to (1-4) below may be supported. As concrete methods of (1-1) to (1-4) below, the methods (in dynamic switching between disabling and enabling of a transform precoder) described above may be employed.
(1-1) A UE may receive an explicit indication indicating enabling/disabling (DFT-s-OFDM/CP-OFDM) of transformPrecoder by DCI (explicit signaling)
(1-2) A UE may receive an implicit indication indicating enabling/disabling (DFT-s-OFDM/CP-OFDM) of transformPrecoder by DCI (implicit signaling)
(1-3) A UE may receive an explicit indication indicating enabling/disabling (DFT-s-OFDM/CP-OFDM) of transformPrecoder by a MAC CE (explicit signaling)
(1-4) A UE may receive an implicit indication indicating enabling/disabling (DFT-s-OFDM/CP-OFDM) of transformPrecoder by a MAC CE (implicit signaling)

The methods of (1-1) to (1-4) may be applied to a Type 1 CG-PUSCH separately from other types of PUSCH (Type 2 CG-PUSCH, DG-PUSCH). Alternatively, as the methods of (1-1) to (1-4), the same method as a method for other types of PUSCH may be applied to a Type 1 CG-PUSCH.

For an existing Type 1 CG-PUSCH, DCI is not used for scheduling. Hence, when (1-1) or (1-2) above is applied, it is preferable to newly define DCI. For example, as DCI of (1-1) or (1-2) above, either (2-1) or (2-2) below may be applied.
(2-1) DCI for scheduling UL/DL unicast data may be applied. Note that a UL/DL-SCH actually scheduled by DCI need not be present.
(2-2) DCI for scheduling one other than unicast data may be applied. For example, this DCI may be applied when group common DCI is used.

According to this embodiment, processing for a case where dynamic switching of a Type 1 CG-PUSCH waveform is applied can be made clear.

### EMBODIMENT 4.2

Dynamic switching of a Type 2 CG-PUSCH (PUSCH transmission configured by higher layer signaling and activated/deactivated by DCI) waveform may be applied, and at least one method of (1-1) to (1-4) in Embodiment 4.1 may be supported.

The methods of (1-1) to (1-4) may be applied to a Type 2 CG-PUSCH separately from other types of PUSCH (Type 1 CG-PUSCH, DG-PUSCH). Alternatively, as the methods of (1-1) to (1-4), the same method as a method for other types of PUSCH may be applied to a Type 2 CG-PUSCH.

For an existing Type 2 CG-PUSCH, DCI for activation/deactivation is used, and hence the DCI may be reused. Specifically, as DCI of (1-1) or (1-2) above, either (2-1) or (2-2) above may be applied.
(2-1) DCI for scheduling UL/DL unicast data may be applied. Note that a UL/DL-SCH actually scheduled by DCI need not be present. For example, DCI for activating/deactivating a Type 2 CG-PUSCH may be applied.
(2-2) DCI for scheduling one other than unicast data may be applied. For example, this DCI may be applied when group common DCI is used.

According to this embodiment, processing for a case where dynamic switching of a Type 2 CG-PUSCH waveform is applied can be made clear.

### EMBODIMENT 5

Dynamic switching of a message 3/message A PUSCH (PUSCH scheduled by a random access response (RAR)) waveform may be applied, and at least one method of (1-1) to (1-4) of Embodiment 4.1 may be supported. Alternatively, (1-5) below may be employed.
(1-5) A UE may receive an explicit/implicit indication indicating enabling/disabling (DFT-s-OFDM/CP-OFDM) of transformPrecoder by a RAR.

The methods of (1-1) to (1-5) may be applied to a message 3/message A PUSCH separately from other types of PUSCH (Type 1/Type 2 CG-PUSCH, DG-PUSCH). Alternatively, as the methods of (1-1) to (1-5), the same method as a method for other types of PUSCH may be applied to a message 3/message A PUSCH.

For an existing message 3/message A PUSCH, DCI for activation/deactivation is used, and hence the DCI may be reused. Specifically, as DCI of (1-1) or (1-2) above, either (2-1) or (2-2)

### Above May Be Applied.

(2-1) DCI for scheduling UL/DL unicast data may be applied. Note that a UL/DL-SCH actually scheduled by DCI need not be present. For example, DCI may be DCI 1 0 having a cyclic redundancy check (CRC) scrambled by RA Radio Network Temporary Identifier (RNTI) or a message B RNTI.
(2-2) DCI for scheduling one other than unicast data may be applied. For example, this DCI may be applied when group common DCI is used.

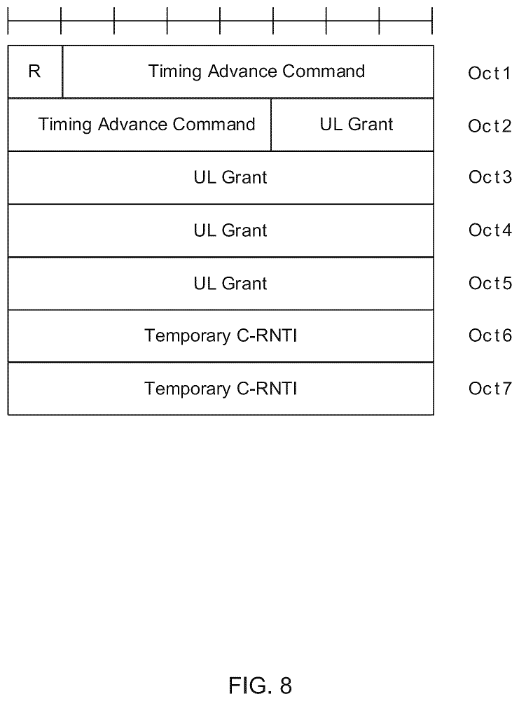

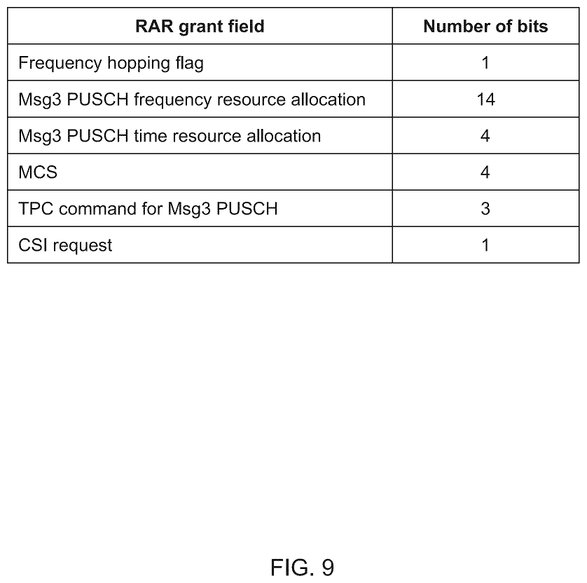

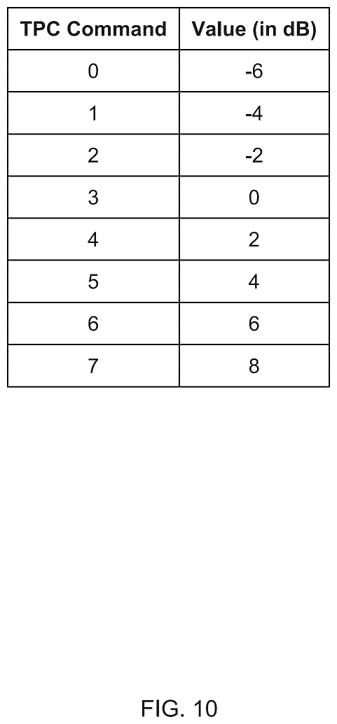

For dynamic waveform switching of a message 3/message A PUSCH, at least one of (3-1) and (3-2) below related to RAR based indication may be supported. A UE may dynamically switching a waveform of a message 3 PUSCH or a message A PUSCH, based on at least one of a MAC subheader and a MAC payload for RAR.
(3-1) A reserved bit (R) for a MAC subheader/MAC payload for RAR may be released to be used for dynamic waveform switching. For example, “R” in the first octet (i.e., adjacent to Timing Advance Command) of a MAC payload shown in FIG. 8 may indicate dynamic waveform switching.
(3-2) Based on an existing RAR grant field (UL Grant) shown in FIG. 9, implicit indication may be performed. For example, when a modulation and coding scheme (MCS) in UL Grant indicates a specific MCS, enabling/disabling of transformPrecoder may be configured for a message 3/message A PUSCH. For example, when a value corresponding to a TPC command for a message 3 PUSCH in UL Grant (FIG. 9 and FIG. 10) is a specific value or is larger than/smaller than a specific threshold, enabling/disabling of transformPrecoder may be configured for a message 3/message A PUSCH.

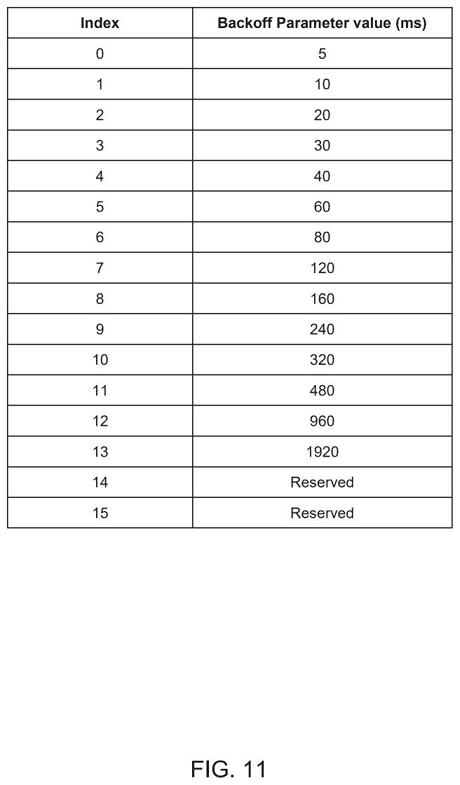

When a Backoff Parameter value corresponding to a Backoff Indicator (BI) field included in a MAC subheader for RAR (FIG. 11) is a specific value or is larger than/smaller than a specific threshold, enabling/disabling of transformPrecoder may be configured for a message 3/message A PUSCH. Alternatively, when an Extension (E) field, a Type (T) field, and a Random Access Preamble IDentifier (RAPID) field included in a MAC subheader for RAR indicate specific values, enabling/disabling of transformPrecoder may be configured for a message 3/message A PUSCH.

This embodiment may be employed when a specific condition is satisfied. The specific condition may be that a PRACH for triggering a RAR is transmitted in a specific RA resource based on an RACH resource partition configuration.

According to this embodiment, processing for a case where dynamic switching of a message 3/message A CG-PUSCH waveform is applied can be made clear. In addition, when a RAR based indication is used for dynamic waveform switching of a message 3/message A PUSCH, an existing MAC subheader/payload can be used, which can hence suppress an increase in communication overhead.

### <Supplements>

### {Notification of Information to UE}

Notification of any information to a UE (from a network (NW) (for example, a base station (BS))) (in other words, reception of any information from the BS in the UE) in the above-described embodiments may be performed by using physical layer signaling (for example, DCI), higher layer signaling (for example, RRC signaling, MAC CE), a specific signal/channel (for example, a PDCCH, a PDSCH, a reference signal), or a combination of these.

When the notification is performed by a MAC CE, the MAC CE may be identified by a new logical channel ID (LCID) not defined in an existing standard being included in a MAC subheader.

When the notification is performed by DCI, the notification may be performed by a specific field of the DCI, a radio network temporary identifier (RNTI) used for scrambling of cyclic redundancy check (CRC) bits given to the DCI, a format of the DCI, or the like.

Notification of any information to a UE in the above-described embodiments may be performed periodically, semi-persistently, or aperiodically.

### {Notification of Information From UE}

Notification of any information from a UE (to an NW) (in other words, transmission/reporting of any information to the BS in the UE) in the above-described embodiments may be performed by using physical layer signaling (for example, UCI), higher layer signaling (for example, RRC signaling, MAC CE), a specific signal/channel (for example, a PUCCH, a PUSCH, a PRACH, a reference signal), or a combination of these.

When the notification is performed by a MAC CE, the MAC CE may be identified by a new LCID not defined in existing standards being included in a MAC subheader.

When the notification is performed by UCI, the notification may be transmitted by using a PUCCH or a PUSCH.

Notification of any information from a UE in the above-described embodiments may be performed periodically, semi-persistently, or aperiodically.

### {Regarding Application of Each Embodiment}

At least one of the above-described embodiments may be applied to a case satisfying a specific condition. The specific condition may be defined in specifications, or a UE/BS may be notified of the specific condition by using higher layer signaling/physical layer signaling.

At least one of the above-described embodiments may be applied only to a UE that has reported a specific UE capability or that supports the specific UE capability.

The specific UE capability may indicate at least one of the following:
supporting of specific processing/operation/control information for at least one of the embodiments above

The specific UE capability may be capability applied over all the frequencies (commonly irrespective of frequency), capability per frequency (for example, one or a combination of cell, band, band combination, BWP, component carrier, and the like), capability per frequency range (for example, Frequency Range 1(FR1), FR2, FR3, FR4, FR5, FR2-1, FR2-2), capability per subcarrier spacing (SCS), or capability per Feature Set (FS) or Feature Set Per Component-carrier (FSPC).

The specific UE capability may be capability applied over all the duplex schemes (commonly irrespective of duplex scheme) or capability per duplex scheme (for example, time division duplex (TDD) or frequency division duplex (FDD)).

At least one of the above-described embodiments may be applied when the UE is configured/activated/triggered with specific information related to the above-described embodiment (or performance of the operation of the above-described embodiment) by higher layer signaling/physical layer signaling. For example, the specific information may be any RRC parameter for a specific release (for example, Rel. 18/19), or the like.

When the UE does not support at least one of the specific UE capabilities above or is not configured with the specific information, operation of Rel. 15/16 may be applied, for example.

### (Supplementary Notes)

Regarding one embodiment of the present disclosure, the following supplementary notes of the invention will be given.
{Supplementary Note 1}

A terminal including:
a receiving section that receives a configuration of a transform precoder of an RRC parameter to which enabled or disabled is configured and a configuration of a maximum rank to which a specific value or a value smaller than the specific value is configured, when a physical uplink shared channel (PUSCH) waveform can be dynamically switched; and
a control section that controls transmission of the PUSCH.

### {Supplementary Note 2}

The terminal according to supplementary note 1, wherein the transform precoder is configured to enabled.

### {Supplementary Note 3}

The terminal according to supplementary note 1, wherein the transform precoder is configured to disabled.

### {Supplementary Note 4}

The terminal according to any one of supplementary notes 1 to 3, wherein the maximum rank is configured to 1.

Regarding one embodiment of the present disclosure, the following supplementary notes of the invention will further be given.

### {Supplementary Note 1}

A terminal including:
a receiving section that receives downlink control information (DCI); and
a control section that ignores, when a physical uplink shared channel (PUSCH) waveform can be dynamically switched and a discrete Fourier transform-spread-orthogonal frequency division multiplexing (DFT-s-OFDM) waveform is indicated for the PUSCH, at least one of a demodulation reference signal (DMRS) sequence initialization field and a phase tracking reference signal (PTRS)-DMRS related field of the DCI.

### {Supplementary Note 2}

The terminal according to supplementary note 1, wherein
when the PUSCH waveform can be dynamically switched and the DFT-s-OFDM waveform is indicated for the PUSCH, the receiving section receives configuration information indicating dynamic switching as resource allocation and receives indication information indicating type 1 as frequency domain resource allocation (FDRA) by the DCI, and
the control section controls transmission of the PUSCH, based on the configuration information and the indication information.

### {Supplementary Note 3}

The terminal according to supplementary note 1, wherein when the PUSCH waveform can be dynamically switched and the DFT-s-OFDM waveform is indicated for the PUSCH, the receiving section receives configuration information indicating type 1 as resource allocation, and
the control section controls transmission of the PUSCH, based on the configuration information.

### {Supplementary Note 4}

The terminal according to any one of supplementary notes 1 to 3, wherein
when the PUSCH waveform can be dynamically switched and the DFT-s-OFDM waveform is indicated for the PUSCH, the receiving section receives configuration information indicating that use of interlace for the PUSCH is enabled, and
the control section controls transmission of the PUSCH, based on the configuration information.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

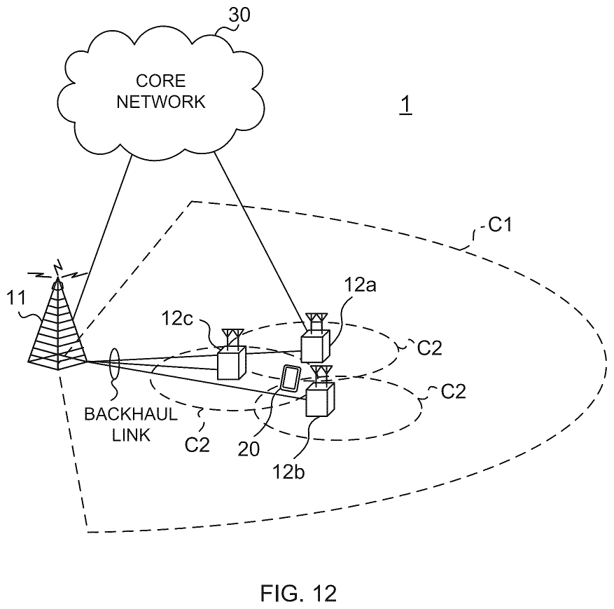

FIG. 12 is a diagram to show an example of a schematic structure of the radio communication system according to one embodiment. The radio communication system 1 (which may be referred to simply as a system 1) may be a system implementing communication using Long Term Evolution (LTE), 5th generation mobile communication system New Radio (5G NR) and so on the specifications of which have been drafted by the Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub−6 GHZ), and FR2 may be a frequency band which is higher than 24 GHZ (above−24 GHZ). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The core network 30 may include network functions (NFs) such as a User Plane Function (UPF), an Access and Mobility management Function (AMF), a Session Management Function (SMF), Unified Data Management (UDM), an ApplicationFunction (AF), a Data Network (DN), a Location Management Function (LMF), and operation, administration, and maintenance (Management) (OAM), for example. Note that a plurality of functions may be provided by one network node. Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH and “DL data” may be used interchangeably and the PUSCH and “UL data”may be used interchangeably.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be used interchangeably.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block, ” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

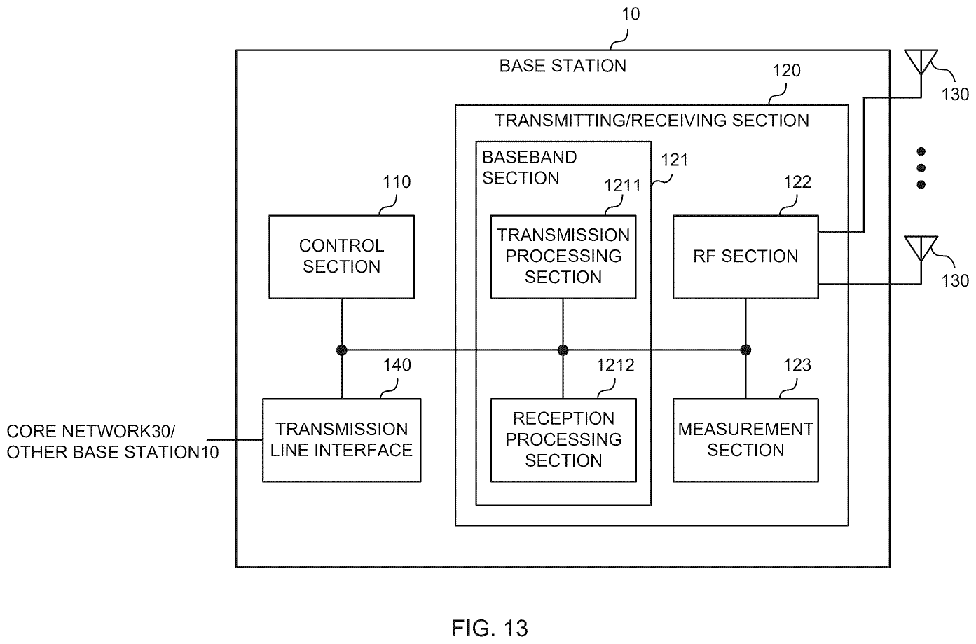

FIG. 13 is a diagram to show an example of a structure of the base station according to one embodiment. The base station 10 includes a control section 110, a transmitting/receiving section 120, transmitting/receiving antennas 130 and a transmission line interface (transmission line interface) 140. Note that the base station 10 may include one or more control sections 110, one or more transmitting/receiving sections 120, one or more transmitting/receiving antennas 130, and one or more transmission line interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the transmission line interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The Transmission line interface 140 may perform transmission/reception (backhaul signaling) of a signal with an apparatus included in the core network 30 (for example, a network node that provides an NF) or other base stations 10, and so on, and, for example, acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the transmission line interface 140.

The transmitting/receiving section 120 may transmit a configuration of a transform precoder of an RRC parameter to which enabled or disabled is configured and a configuration of a maximum rank to which a specific value or a value smaller than the specific value is configured, when a physical uplink shared channel (PUSCH) waveform can be dynamically switched.

The control section 110 may control reception of the PUSCH.

The transmitting/receiving section 120 may transmit downlink control information (DCI).

The control section 110 may assume that, when a physical uplink shared channel (PUSCH) waveform can be dynamically switched and a discrete Fourier transform spread OFDM (DFT-s-OFDM) waveform is indicated for the PUSCH, at least one of a demodulation reference signal (DMRS) sequence initialization field and a phase tracking reference signal (PTRS)-DMRS related field of the DCI is ignored.

The transmitting/receiving section 120 may transmit a configuration indicating that a physical uplink shared channel (PUSCH) waveform can be dynamically switched and transmit downlink control information (DCI) and a Media Access Control Control Element (MAC CE).

The control section 110 may control reception of a particular type of PUSCH dynamically switched based on at least one of the DCI and the MAC CE.

### (User Terminal)

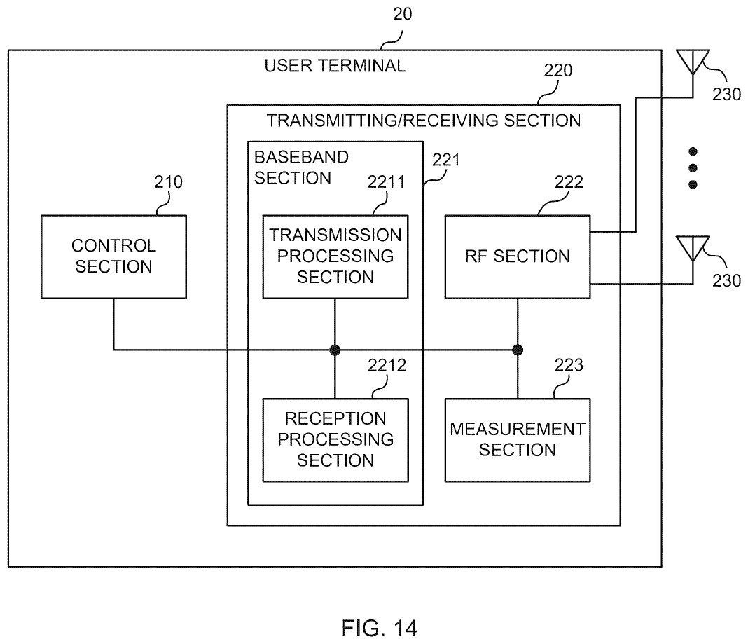

FIG. 14 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223.

The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a given channel (for example, PUSCH), the DET processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may receive a configuration of a transform precoder of an RRC parameter to which enabled or disabled is configured and a configuration of a maximum rank to which a specific value or a value smaller than the specific value is configured, when a physical uplink shared channel (PUSCH) waveform can be dynamically switched.

The control section 210 may control transmission of the PUSCH. The transform precoder may be configured at enabled. The transform precoder may be configured at disabled. The maximum rank may be configured at 1.

The transmitting/receiving section 220 may receive downlink control information (DCI).

The control section 210 may ignore, when a physical uplink shared channel (PUSCH) waveform can be dynamically switched and a discrete Fourier transform spread OFDM (DFT-s-OFDM) waveform is indicated for the PUSCH, at least one of a demodulation reference signal (DMRS) sequence initialization field and a phase tracking reference signal (PTRS)-DMRS related field of the DCI.

When the PUSCH waveform can be dynamically switched and the DFT-s-OFDM waveform is indicated for the PUSCH, the transmitting/receiving section 220 may receive configuration information indicating dynamic switching as resource allocation and receive indication information indicating type 1 as frequency domain resource allocation (FDRA) by the DCI. The control section 210 may control transmission of the PUSCH, based on the configuration information and the indication information.

When the PUSCH waveform can be dynamically switched and the DFT-s-OFDM waveform is indicated for the PUSCH, the transmitting/receiving section 220 may receive configuration information indicating type 1 as resource allocation. The control section 210 may control transmission of the PUSCH, based on the configuration information.

When the PUSCH waveform can be dynamically switched and the DFT-s-OFDM waveform is indicated for the PUSCH, the transmitting/receiving section 220 may receive configuration information indicating that use of interlace for the PUSCH is enabled. The control section 210 may control transmission of the PUSCH, based on the configuration information.

The transmitting/receiving section 220 may receive a configuration indicating that a physical uplink shared channel (PUSCH) waveform can be dynamically switched and receive downlink control information (DCI) and a Media Access Control Control Element (MAC CE).

The control section 210 may dynamically switch a particular type of PUSCH dynamically, based on at least one of the DCI and the MAC CE. The particular type of PUSCH may be a type 1 configured grant (CG)-PUSCH or a type 2 CG-PUSCH. The particular type of PUSCH may be a message 3 PUSCH or a message A PUSCH.

The control section 210 may dynamically switch a waveform of the message 3 PUSCH or the message A PUSCH, based on at least one of a Media Access Control (MAC) subheader and a MAC payload for random access response (RAR).

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate apparatuses (for example, via wire, wireless, or the like) and using these apparatuses. The functional blocks may be implemented by combining software into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but functions are by no means limited to these. For example, a functional block (component) to implement a function of transmission may be referred to as a “transmitting section (transmitting unit), ” a “transmitter,” or the like. The method for implementing each component is not particularly limited as described above.

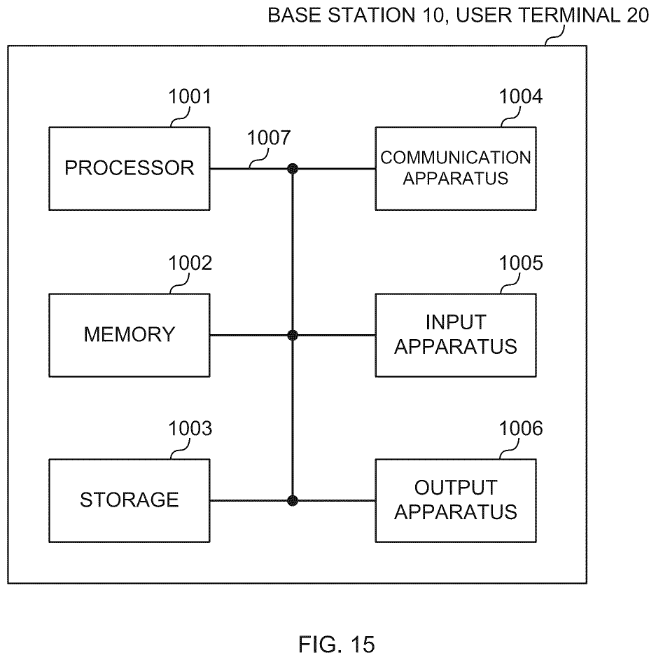

For example, a base station, a user terminal, and so on according to one embodiment of the present disclosure may function as a computer that executes the processes of the radio communication method of the present disclosure. FIG. 15 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably used. The hardware structure of the base station 10 and the user terminal 20 may be configured to include one or more of apparatuses shown in the drawings, or may be configured not to include part of apparatuses.

For example, although one processor 1001 is shown in the drawings, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminal 20 is implemented, for example, by allowing given software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least a part of the control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least a part of the operations explained in the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “auxiliary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the transmitting/receiving section 120 (220), the transmitting/receiving antenna 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor or the like). The output apparatus 1006 is an output device that allows sending output to the outside (for example, a display, a speaker, a Light Emitting Diode (LED) lamp or the like). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between apparatuses.

Also, the base station 10 and the user terminal 20 may be structured to include hardware such as a microprocessor, a Digital Signal Processor (DSP), an Application Specific Integrated Circuit (ASIC), a Programmable Logic Device (PLD), a Field Programmable Gate Array (FPGA), and so on, and a part or all of the functional blocks may be implemented by the hardware. For example, the processor 1001 may be implemented with at least one of these pieces of hardware.

### (Variations)

It should be noted that a term used in the present disclosure and a term required for understanding of the present disclosure may be replaced by a term having the same or similar meaning. For example, a channel, a symbol, and a signal (or signaling) may be interchangeably used. Further, a signal may be a message. A reference signal may be abbreviated as an RS, and may be referred to as a pilot, a pilot signal or the like, depending on which standard applies. Furthermore, a component carrier (CC) may be referred to as a cell, a frequency carrier, a carrier frequency and so on.

### A Radio Frame May Be Constituted of One or a Plurality of

periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a given signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols in number less than the slot. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably used.

For example, one subframe may be referred to as a “TTI,” a plurality of consecutive subframes may be referred to as a “TTI,” or one slot or one mini-slot may be referred to as a “TTI.” In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot,” a “mini-slot,” or the like, instead of a “subframe.”

Here, a TTI refers to the minimum time unit of scheduling in radio communication, for example. For example, in LTE systems, a base station performs, for user terminals, scheduling of allocating of radio resources (such as a frequency bandwidth and transmit power that are available for each user terminal) in TTI units. Note that the definition of TTIs is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIS (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot, ” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair”and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell,” a “carrier,” and so on in the present disclosure may be used interchangeably with a “BWP.”

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

### Further, the Information, Parameters, and so on Described in

the present disclosure may be expressed using absolute values or relative values with respect to given values, or may be expressed using another corresponding information. For example, a radio resource may be specified by a given index.

The names used for parameters and so on in the present disclosure are in no respect used as limitations. Furthermore, mathematical expressions that use these parameters, and so on may be different from those explicitly disclosed in the present disclosure. Since various channels (PUCCH, PDCCH, and so on) and information elements may be identified by any suitable names, the various names allocated to these various channels and information elements are in no respect used as limitations.

The information, signals, and so on described in the present disclosure may be represented by using any of a variety of different technologies. For example, data, an instruction, a command, information, a signal, a bit, a symbol, a chip, and so on, described throughout the description of the present application, may be represented by a voltage, an electric current, electromagnetic waves, magnetic fields, a magnetic particle, optical fields, a photon, or any combination thereof.

Also, information, signals, and so on can be output at least one of from a higher layer to a lower layer and from a lower layer to a higher layer. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or added. The information, signals, and so on that has been output may be deleted. The information, signals, and so on that has been input may be transmitted to another apparatus.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be notified using, for example, MAC control elements (MAC CES).

Also, notification of given information (for example, notification of “X”) does not necessarily have to be performed explicitly, and can be performed implicitly (by, for example, not reporting this given information or reporting another piece of information).

A decision may be realized by a value (0 or 1) represented by one bit, by a boolean value (true or false), or by comparison of numerical values (e.g., comparison with a given value).

Software, irrespective of whether referred to as “software,” “firmware,” “middleware,” “microcode,” or “hardware description language,” or called by other terms, should be interpreted broadly to mean instructions, instruction sets, codes, code segments, program codes, programs, subprograms, software modules, applications, software applications, software packages, routines, subroutines, objects, executable files, execution threads, procedures, functions, and the like.

Also, software, instructions, information, and the like may be transmitted and received via a transmission medium. For example, when software is transmitted from a website, a server, or other remote sources by using at least one of wired technologies (coaxial cable, fiber optic cable, twisted-pair cable, digital subscriber line (DSL), and so on) and wireless technologies (infrared radiation, microwaves, and so on), at least one of these wired technologies and wireless technologies is also included in the definition of the transmission medium.

The terms “system” and “network” used in the present disclosure may be used interchangeably. The “network” may mean an apparatus (for example, a base station) included in the network.

In the present disclosure, the terms such as “precoding,” a “precoder,” a “weight (precoding weight), ” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on may be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,”a “pico cell,”and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, transmitting information to the terminal by the base station may be interchangeably interpreted as instructing the terminal to perform control/operation based on the information by the base station.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,”or some other appropriate terms in some cases.

At least one of a base station and a mobile station may be referred to as a “transmitting apparatus,” a “receiving apparatus,” a “radio communication apparatus” or the like. Note that at least one of a base station and a mobile station may be a device mounted on a moving object or a moving object itself, and so on.

The moving object is a movable object with any moving speed, and naturally, it also includes a moving object stopped. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an autonomous car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

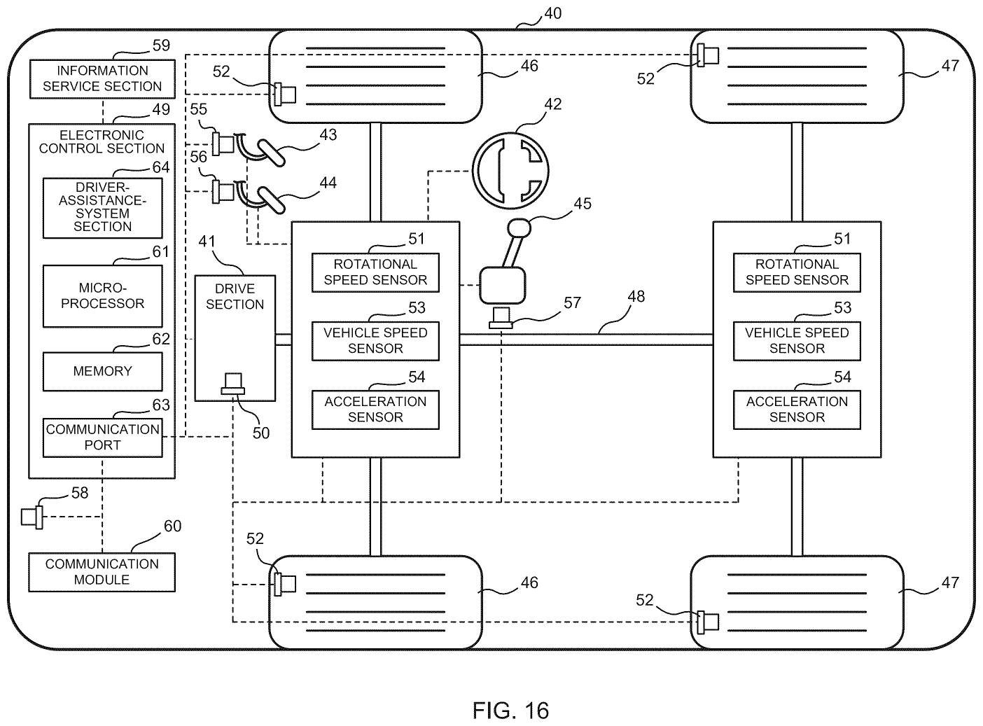

FIG. 16 is a diagram to show an example of a vehicle according to one embodiment. A vehicle 40 includes a drive section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The drive section 41 includes, for example, at least one of an engine, a motor, and a hybrid of an engine and a motor. The steering section 42 includes at least a steering wheel (also referred to as a handle), and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (10) port) 63. The electronic control section 49 receives, as input, signals from the various sensors 50 to 58 provided in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes: various devices for providing (outputting) various pieces of information such as driving information, traffic information, and entertainment information, such as a car navigation system, an audio system, a speaker, a display, a television, and a radio; and one or more ECUs that control these devices. The information service section 59 provides various pieces of information/services (for example, multimedia information/multimedia service) to an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A drive-assistance-system section 64 includes: various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor; and one or more ECUS that control these devices. The drive-assistance-system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, the communication module 60 transmits and receives data (information), via the communication port 63, to and from the drive section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 is a communication device that can be controlled by the microprocessor 61 of the electronic control section 49 and that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals input from the various sensors 50 to 58 to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the received information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may control the drive section 41, the steering section 42, the accelerator pedal 43, the brake pedal 44, the shift lever 45, the right and left front wheels 46, the right and left rear wheels 47, the axle 48, the various sensors 50 to 58, and the like provided in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D), ” “Vehicle-to-Everything (V2X) ,” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as a base station. In this case, the base station 10 may have the functions of the user terminal 20 described above.

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

Each aspect/embodiment described in the present disclosure may be used independently, may be used in combination, or may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) for application.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of”and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “deciding (determining)” as in the present disclosure herein may encompass a wide variety of actions. For example, “deciding (determining) ” may be interpreted to mean making “decisions (determinations)” about judging, calculating, computing, processing, deriving, investigating, looking up, search and inquiry (for example, searching a table, a database, or some other data structures), ascertaining, and so on.

Furthermore, “deciding (determining)” may be interpreted to mean making “decisions (determinations)” about receiving (for example, receiving information), transmitting (for example, transmitting information), input, output, accessing (for example, accessing data in a memory), and so on.

In addition, “deciding (determining)” as used herein may be interpreted to mean making “decisions (determinations)” about resolving, selecting, choosing, establishing, comparing, and so on. In other words, “deciding (determining)” may be interpreted to mean making “decisions (determinations)”about some action.

“Decide/deciding (determine/determining)” may be used interchangeably with “assume/assuming,” “expect/expecting,” “consider/considering,”and the like.

“The maximum transmit power” described in the present disclosure may mean a maximum value of the transmit power, may mean the nominal maximum transmit power (the nominal UE maximum transmit power), or may mean the rated maximum transmit power (the rated UE maximum transmit power).

The terms “connected,” “coupled,” or any variation of these terms as used in the present disclosure mean any direct or indirect connections or coupling between two or more elements, and may include the presence of or more intermediate elements between two elements that are “connected” or “coupled” to each other. The coupling or connection between the elements may be physical, logical, or a combination thereof. For example, “connection” may be interpreted as “access.”In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” It should be noted that the phrase may mean that “A and B are each different from C.” The terms “separate,” “coupled,” and so on may be interpreted similarly to “different.”

In the case where the terms “include,” “including,” and variations thereof are used in the present disclosure, these terms are intended to be comprehensive, in a manner similar to the term “comprising.” Furthermore, the term “or” used in the present disclosure is not intended to be an “exclusive or.”

For example, in the present disclosure, where an article such as “a,” “an,” and “the” is added by translation, the present disclosure may include that a noun after the article is in a plural form.

In the Present Disclosure, “equal to or Less Than,” “less than,” “equal to or more than,” “more than,” “equal to,” and the like may be used interchangeably. In the present disclosure, words such as “good,” “bad,” “large,” “small,” “high,” “low,” “early,” “late,” “wide,” “narrow,” and the like may be used interchangeably irrespective of positive degree, comparative degree, and superlative degree. In the present disclosure, expressions obtained by adding “i-th” (i is any integer) to words such as “good,” “bad,” “large,” “small,” “high,” “low,” “early,” “late,” “wide,” “narrow,” and the like may be used interchangeably irrespective of positive degree, comparative degree, and superlative degree (for example, “best” may be used interchangeably with “i-th best,” and vice versa).

In the present disclosure, “of,” “for,” “regarding,” “related to,” “associated with,” and the like may be used interchangeably.

Now, although the invention according to the present disclosure has been described in detail above, it is apparent to a person skilled in the art that the invention according to the present disclosure is by no means limited to the embodiments described in the present disclosure. Modifications, alternatives, replacements, etc., of the invention according to the present disclosure may be possible without departing from the subject matter and the scope of the present invention defined based on the descriptions of claims. The description of the present disclosure is provided only for the purpose of explaining examples, and should by no means be construed to limit the invention according to the present disclosure in any way.

1. A terminal comprising:
a receiving section that receives downlink control information (DCI); and
a control section that ignores, when a physical uplink shared channel (PUSCH) waveform can be dynamically switched and a discrete Fourier transform-spread-orthogonal frequency division multiplexing (DFT-s-OFDM) waveform is indicated for the PUSCH, at least one of a demodulation reference signal (DMRS) sequence initialization field and a phase tracking reference signal (PTRS)-DMRS related field of the DCI.

2. The terminal according to claim 1, wherein
when the PUSCH waveform can be dynamically switched and the DFT-s-OFDM waveform is indicated for the PUSCH, the receiving section receives configuration information indicating dynamic switching as resource allocation and receives indication information indicating type 1 as frequency domain resource allocation (FDRA) by the DCI, and
the control section controls transmission of the PUSCH, based on the configuration information and the indication information.

3. The terminal according to claim 1, wherein
when the PUSCH waveform can be dynamically switched and the DFT-s-OFDM waveform is indicated for the PUSCH, the receiving section receives configuration information indicating type 1 as resource allocation, and
the control section controls transmission of the PUSCH, based on the configuration information.

4. The terminal according to claim 1, wherein
when the PUSCH waveform can be dynamically switched and the DFT-s-OFDM waveform is indicated for the PUSCH, the receiving section receives configuration information indicating that use of interlace for the PUSCH is enabled, and
the control section controls transmission of the PUSCH, based on the configuration information.

5. A radio communication method for a terminal, the radio communication method comprising:
receiving downlink control information (DCI); and
ignoring, when a physical uplink shared channel (PUSCH) waveform can be dynamically switched and a discrete Fourier transform-spread-orthogonal frequency division multiplexing (DFT-s-OFDM) waveform is indicated for the PUSCH, at least one of a demodulation reference signal (DMRS) sequence initialization field and a phase tracking reference signal (PTRS)-DMRS related field of the DCI.

6. A base station comprising:
a transmitting section that transmits downlink control information (DCI); and
a control section that assumes that, when a physical uplink shared channel (PUSCH) waveform can be dynamically switched and a discrete Fourier transform-spread-orthogonal frequency division multiplexing (DFT-s-OFDM) waveform is indicated for the PUSCH, at least one of a demodulation reference signal (DMRS) sequence initialization field and a phase tracking reference signal (PTRS)-DMRS related field of the DCI is ignored.
